(19) United States
(12) Patent Application Publication
(10) Pub. No.: US 2010/0276831 A1
(43) Pub. Date: Nov. 4, 2010

(54) COLD-SHRINKABLE TYPE RUBBER INSULATION SLEEVE AND METHOD OF MANUFACTURING

(75) Inventors: Shozo KOBAYASHI, Tokyo (JP); Kozo Kurita, Tokyo (JP); Isao Takaoka, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: FURUKAWA ELECTRIC CO., LTD., Tokyo (JP)

(21) Appl. No.: 12/838,318

(22) Filed: Jul. 16, 2010

Related U.S. Application Data
(63) Continuation of application No. 11/589,108, filed on Oct. 30, 2006.
Application No. 11/589,108 is a division of application No. 10/868,843, filed on Jun. 17, 2004, now abandoned.

(30) Foreign Application Priority Data
Jun. 19, 2003 (JP) 2003-174964

(51) Int. Cl. B29C 45/16

(52) U.S. Cl. 264/104

(57) ABSTRACT

A cold-shrinkable type rubber insulation sleeve includes a reinforced insulation sleeve, a semiconductive stress-relief cone, an internal semiconductive layer, and an external semiconductive layer. The reinforced insulation sleeve, the semiconductive stress-relief cone, and the internal semiconductive layer are formed by molding, and the external semiconductive layer is formed by coating.

### CROSS-REFERENCE TO RELATED APPLICATIONS

The present application is a continuation of and claims the benefit of priority under 35 U.S.C. §120 from U.S. application Ser. No. 11/589,108, filed Oct. 30, 2006, which is incorporated herein by reference in its entirety. U.S. application Ser. No. 11/589,108 is a divisional application of U.S. application Ser. No. 10/868,843, filed Jun. 16, 2004, which is based upon and claims the benefit of priority under U.S.C. §119 from prior Japanese Patent Application No. 2003-174,964, filed Jun. 19, 2003.

### BACKGROUND OF THE INVENTION

1) Field of the Invention

The present invention relates to a cold-shrinkable type rubber insulation sleeve that is used for a joint of power cables such as high-voltage CV (cross-linked polyethylene insulated vinyl sheath) cables.

2) Description of the Related Art

There are various kinds of structures for insulation joints for high-voltage CV cables. Such structures include an extrusion molded type, a pre-fabricated type, a tape wrapping molded type, and a tape wrapping type. In addition, a one-piece joint that has an excellent assembility and uses a cold-shrinkable type rubber sleeve has become available and been spreading recently with remarkable improvements in rubber molding technology.

As shown in FIGS. 3C and 4C, a typical cold-shrinkable type rubber insulation sleeve includes a reinforced insulation sleeve 1, two semiconductive stress-relief cones 3, an internal semiconductive layer 5, and an external semiconductive layer 7. Each of these components are molded with rubber material, which is elastic at room temperature, to form a one-piece, tubular cold-shrinkable type rubber insulation sleeve. One semiconductive stress-relief cone 3 is formed at each end of the tubular reinforced insulation sleeve 1. The internal semiconductive layer 5 is arranged inside the tubular reinforced insulation sleeve 1. The external semiconductive layer 7 is formed around and on an outer surface of the reinforced insulation sleeve 1.

The cold-shrinkable type rubber insulation sleeve is manufactured, for example, as follows. The internal semiconductive layer 5 is molded in advance by injecting a semiconductive rubber material in a special mold (not shown). The internal semiconductive layer 5 is then arranged at a predetermined position around a core 9 (see FIG. 3A). The molding of the internal semiconductive layer 5 may include vulcanization.

Then, a mold (not shown) for the reinforced insulation sleeve 1 is set around the core 9 and the internal semiconductive layer 5. The reinforced insulation sleeve 1, with a slope 1a at each end (see FIG. 3B), is molded by injecting a rubber material into the mold. The reinforced insulation sleeve 1 gradually becomes thin at the slope 1a.

Then the mold for the reinforced insulation sleeve 1 is replaced with a mold (not shown) for the external semiconductive layer 7. The external semiconductive layer 7 is molded by injecting a semiconductive rubber material into this mold (see FIG. 3C). Thus, the external semiconductive layer 7 is formed around and on an entire outer surface of the reinforced insulation sleeve 1. The semiconductive stress-relief cone 3 that has a slope-shaped concave section 3a is fit to each end of the reinforced insulation sleeve 1 while the mold for the external semiconductive layer 7 and the core 9 are still at their positions. Then, the mold for the external semiconductive layer 7 and the core 9 are removed. Thus, formation of the cold-shrinkable type rubber insulation sleeve is completed.

The cold-shrinkable type rubber insulation sleeve can be manufactured even as follows. The internal semiconductive layer 5 and the semiconductive stress-relief cone 3 are molded in advance with the molds specially prepared for each with the semiconductive rubber material. The internal semiconductive layer 5 is arranged at a predetermined position around the core 9 (see FIG. 4A). The semiconductive stress-relief cone 3 is arranged at each side of the internal semiconductive layer 5 in such a manner that there is a predetermined gap between the semiconductive stress-relief cone 3 and the internal semiconductive layer 5. The semiconductive stress-relief cone 3 is set in such a manner that the slope-shaped concave section 3a faces toward the internal semiconductive layer 5.

Then, a mold (not shown) for the reinforced insulation sleeve 1 is set in such a manner that the mold covers both the semiconductive stress-relief cones 3. The reinforced insulation sleeve 1 with a slope 1a at each end (see FIG. 4B) is molded by injecting a rubber material into the mold. Thus, the reinforced insulation sleeve 1 covers the internal semiconductive layer 5, and fills each of the slope-shaped concave section 3a of the semiconductive stress-relief cone 3. The reinforced insulation sleeve 1 gradually becomes thin at the slope 1a.

Then, the mold for the reinforced insulation sleeve 1 is replaced with a mold (not shown) for the external semiconductive layer 7. The mold for the external semiconductive layer 7 is set around the core 9 so as to cover both the reinforced insulation sleeve 1 and the semiconductive stress-relief cones 3. The external semiconductive layer 7 is molded by injecting a semiconductive rubber material into this mold (see FIG. 4C). Thus, the external semiconductive layer 7 is formed around and on entire outer surface of the reinforced insulation sleeve 1 mounting over the semiconductive stress-relief cones 3. Then, the mold for the external semiconductive layer 7 and the core 9 are removed. Thus, formation of the cold-shrinkable type rubber insulation sleeve is completed.

As described above, the conventional cold-shrinkable type rubber insulation sleeve includes the reinforced insulation sleeve 1, the semiconductive stress-relief cone 3, the internal semiconductive layer 5, and the external semiconductive layer 7 that are molded. The method explained with FIGS. 3A to 3C has an advantage in it requires less number of molds; because, both the external semiconductive layer 7 and the semiconductive stress-relief cone 3 are molded with just one mold, which is for the external semiconductive layer 7. On the other hand, the method has a disadvantage that it is difficult to mold the external semiconductive layer 7 and the semiconductive stress-relief cone 3 with a desirable shape and quality. This is because the semiconductive rubber material does not flow well and uniformly in the space in which the external semiconductive layer 7 and the semiconductive stress-relief cone 3 are formed inside the mold due to a great difference in the shape and the thickness between the external semiconductive layer 7 and the semiconductive stress-relief cone 3.

In the method explained with FIGS. 4A to 4C, the above problem can be solved because each of the external semiconductive layer 7 and the semiconductive stress-relief cone 3 is molded with the individual mold specially prepared for each. However, this method has a disadvantage that manufacturing cost increases due to the increased number of the mold.

Moreover, in both the methods, there is a problem that the thickness of the external semiconductive layer 7 may vary. This is because both the methods employ molding to form the external semiconductive layer 7. Molding sometimes causes an unbalance in the flow of the injected semiconductive rubber material inside the mold because of presence of the parts in which the rubber material does not flow well. To solve this problem, the external semiconductive layer 7 is generally formed of thickness of 3 millimeters (mm) or more, i.e., thicker than that is required. This causes inefficiency in manufacturing because more time is required for molding and curing. This also causes increased manufacturing cost because the mold for the external semiconductive layer 7 becomes larger than the mold for the reinforced insulation sleeve 1, and because, if the thickness of the external semiconductive layer 7 is to be made thick, a mold and a press even larger and more expensive are required.

### SUMMARY OF THE INVENTION

It is an object of the present invention to provide a cheaper and more effective method for forming a cold-shrinkable type rubber insulation sleeve.

A cold-shrinkable type rubber insulation sleeve according to an aspect of the present invention includes a reinforced insulation sleeve made mainly with an elastic material that is elastic at room temperature; a semiconductive stress-relief cone that is arranged at each end of the reinforced insulation sleeve; an internal semiconductive layer that is arranged on an inner surface of the reinforced insulation sleeve; and an external semiconductive layer that is arranged around the reinforced insulation sleeve and covers the outer surface of the reinforced insulation sleeve. The reinforced insulation sleeve, the semiconductive stress-relief cone, and the internal semiconductive layer are formed by molding. The external semiconductive layer is formed by coating.

A method of manufacturing a cold-shrinkable type rubber insulation sleeve according to another aspect of the present invention includes forming a tube-shaped internal semiconductive layer by injecting a semiconductive rubber material into a first mold; forming two substantially tube-shaped semiconductive stress-relief cones by injecting a semiconductive rubber material into a second mold; arranging the internal semiconductive layer at a predetermined position around a substantially cylindrical core; arranging the semiconductive stress-relief cone at each side of the internal semiconductive layer in such a manner that there is a predetermined gap between the semiconductive stress-relief cone and the internal semiconductive layer; forming a reinforced insulation sleeve, in such a manner that the reinforced insulation sleeve covers the internal semiconductive layer and both the semiconductive stress-relief cones, by injecting an elastic material into a third mold; removing the third mold; forming a coating that covers an outer surface of the reinforced insulation sleeve mounting over the semiconductive stress-relief cone by spray coating a liquid semiconductive rubber material; drying and vulcanizing the coating to form an external semiconductive layer; and removing the core.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-section of a cold-shrinkable type rubber insulation sleeve according to an embodiment of the present invention;

FIGS. 2A to 2C are cross-sections of a part of the cold-shrinkable type rubber insulation sleeve shown in FIG. 1 that explain steps of a manufacturing process;

FIGS. 3A to 3C are cross-sections of a part of a conventional cold-shrinkable type rubber insulation sleeve that explain steps of a manufacturing process; and

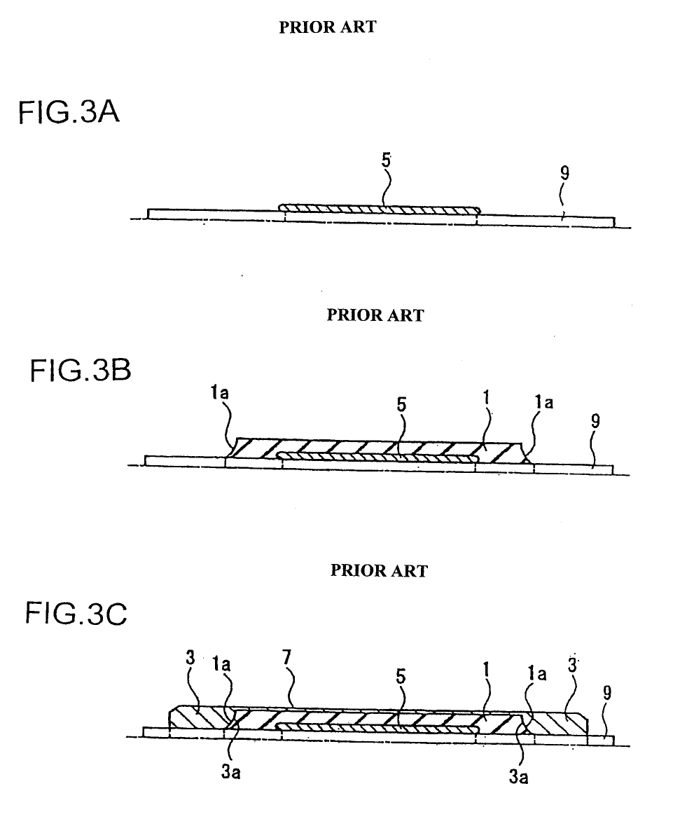

FIGS. 4A to 4C are cross-sections of a part of a conventional cold-shrinkable type rubber insulation sleeve that explain steps of another manufacturing process.

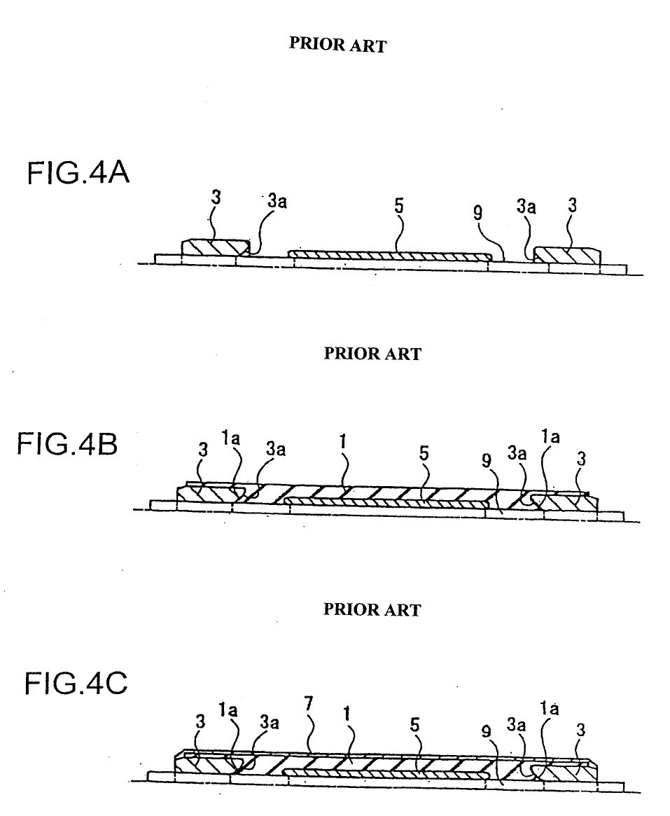

### DETAILED DESCRIPTION

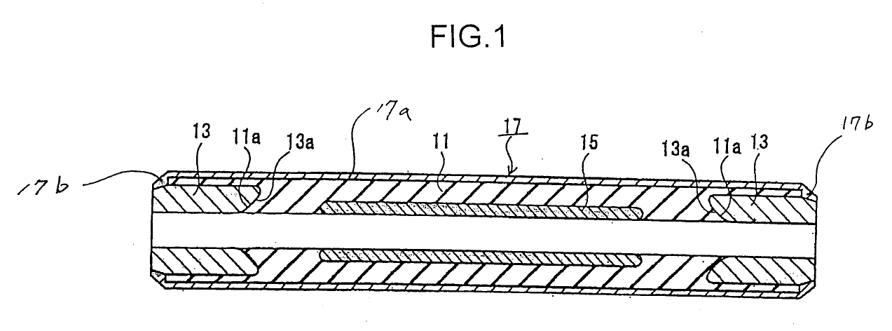

Exemplary embodiments of the present invention are explained with reference to the accompanying drawings. FIG. 1 is a cross-section of a cold-shrinkable type rubber insulation sleeve according to the present invention.

The cold-shrinkable type rubber insulation sleeve is formed into one piece mainly with rubber materials such as Ethylene-Propylene Rubber (EPR) and Silicone Rubber (SR) that are elastic at room temperature. The cold-shrinkable type rubber insulation sleeve includes a reinforced insulation sleeve 11, a semiconductive stress-relief cone 13 at each end of the reinforced insulation sleeve 11, an internal semiconductive layer 15 that is arranged on the inner surface of the reinforced insulation sleeve 11, and an external semiconductive layer 17 that is arranged around the reinforced insulation sleeve 11 to cover the outer surface.

The reinforced insulation sleeve 11 is molded with the rubber material such as Ethylene-Propylene into a tube shape that has a slope 11a at each end. The thickness of the reinforced insulation sleeve 11 gradually becomes thin at each of the slopes 11a.

The semiconductive stress-relief cone 13 is molded with a semiconductive rubber material, which includes the above rubber material and carbon, into a tube shape. The semiconductive stress-relief cone 13 is arranged at each side of the internal semiconductive layer 15 in such a manner that there is a predetermined gap between the semiconductive stress-relief cone 13 and the internal semiconductive layer 15. The semiconductive stress-relief cone 13 is set in such a manner that a slope-shaped concave section 13a faces toward the internal semiconductive layer 15.

The internal semiconductive layer 15 is molded with the semiconductive rubber material. The internal semiconductive layer 15 is embedded inside the tube shaped structure of the reinforced insulation sleeve 11 at the center in such a manner that the inner surface fo the internal semiconductive layer 15 is exposed.

The external semiconductive layer 17 is formed around and on entire outer surface of the reinforced insulation sleeve 11 mounting over the semiconductive stress-relief cone 13. The external semiconductive layer 17 that has the elasticity of 50% or higher is formed by spray coating a liquid semiconductive rubber material with a nozzle jet sprayer, or by applying the semiconductive rubber material with a roller. The external semiconductive layer 17 includes a coating 17a and a contact coating 17b. The coating 17a is tube shaped and of thickness of 1 mm or less. The contact coating 17b is arranged at each end of the coating 17a so as to contact each of the semiconductive stress-relief cone 13. Thus, two of the semiconductive stress-relief cones 13 become conductive with each other through the contact coating 17b and the coating 17a.

In the cold-shrinkable type rubber insulation sleeve according to the present invention, since the reinforced insulation sleeve 11, the semiconductive stress-relief cone 13, and the internal semiconductive layer 15 are formed by molding but the external semiconductive layer 17 is formed by coating, a large mold and a large press to mold the external semiconductive layer 17 are not required. Thus, the manufacturing cost for the cold-shrinkable type rubber insulation sleeve can be lowered.

In addition, it is possible to form the external semiconductive layer 17 easily without considering stagnation or uneven flow of the semiconductive rubber material inside the mold, and without trouble to control the molding pressure. The yield is also improved. Furthermore, it is possible to form the external semiconductive layer 17 thinner in thickness than the conventional molded type without causing nonuniformity in the thickness. This also leads to improved manufacturing efficiency of the cold-shrinkable type rubber insulation sleeve because less time is required for formation, including processes of coating and curing, of the external semiconductive layer 17.

Moreover, because the reinforced insulation sleeve 11, the semiconductive stress-relief cone 13, and the internal semiconductive layer 15 are formed not by coating but by molding, it is possible to obtain the cold-shrinkable type rubber insulation sleeve enough rugged and durable not to be deformed even while the cold-shrinkable type rubber insulation sleeve is kept expanded, or when the cold-shrinkable type rubber insulation sleeve is let shrink at assembly. It is also possible to stably maintain a desirable performance for a long time, and to enhance reliability.

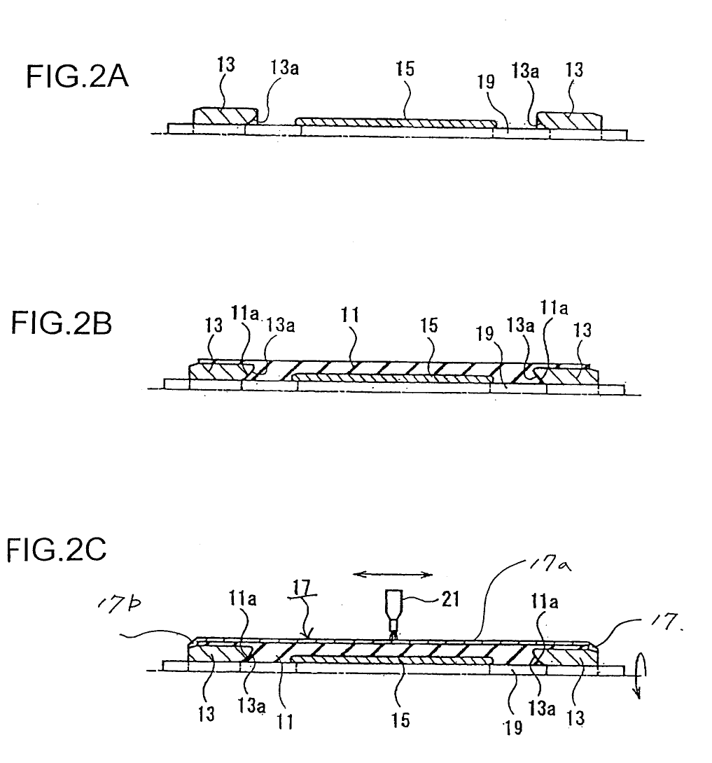

A manufacturing method of the cold-shrinkable type rubber insulation sleeve according to the present invention is explained next with reference to FIGS. 2A to 2C. First, the internal semiconductive layer 15 is molded by injecting a semiconductive rubber material, which contains Silicone Rubber and carbon, into a mold (not shown) specially prepared for the internal semiconductive layer 15. Two of the semiconductive stress-relief cones 13 that include a slope-shaped concave section 13a at one of the edges are also molded by injecting the semiconductive rubber material into a mold specially prepared for the semiconductive stress-relief cone 13 into a substantially tube shape.

Then, the internal semiconductive layer 15 is arranged at a predetermined position, for example at the center, around a cylindrical core 19. Further, the semiconductive stress-relief cone 13, which has been molded, is arranged on each outward side of the internal semiconductive layer 15 in such a manner that there is a predetermined gap between the semiconductive stress-relief cone 13 and the internal semiconductive layer 15, and that the slope-shaped concave section 13a faces toward the internal semiconductive layer 15.

Then, the reinforced insulation sleeve 11 is molded. A mold (not shown) for the reinforced insulation sleeve 11 is set around the core 19 and the internal semiconductive layer 15, so as to mount to cover the semiconductive stress-relief cones to the edges. The reinforced insulation sleeve 11 with a slope 11a at each end (see FIG. 2B) is molded by injecting Silicone Rubber into the mold. The semiconductive insulation sleeve 11 covers the internal semiconductive layer 15, and fills the slope-shaped concave section 13a of the semiconductive stress-relief cone 13. The reinforced insulation sleeve 11 gradually becomes thin at the slope 11a.

Then, the external semiconductive layer 17 is formed as shown in FIG. 2C. After removing the mold for the reinforced insulation sleeve 11, the core 19 on which the reinforced insulation sleeve 11 is set is rotated in a predetermined speed. While rotating the core 19, the liquid semiconductive rubber material, which contains Silicone Rubber and carbon, is splay coated from a nozzle 21 that makes reciprocating motion in a predetermined speed in the direction of the length of the core 19. Thus, the coating 17a that is thin and tube-shaped is formed around the reinforced insulation sleeve 11 by spray coating the semiconductive rubber material as thin as 1 mm or less. The coating 17a covers the outer surface of the reinforced insulation sleeve 11 mounting the semiconductive stress-relief cone 13. A contact coating 17b that contacts with the semiconductive stress-relief cone 13 is also formed at each end of the coating 17a. The coating 17a and the contact coating 17b are dried by applying heat to be vulcanized in a constant temperature bath (not shown) and the like to form the external semiconductive layer 17. Then, the core 19 is removed. Thus, the formation of the cold-shrinkable type rubber insulation sleeve is completed. The cold-shrinkable type rubber insulation sleeve thus manufactured is kept and used with a protective layer that is formed by applying a semiconductive tape, film, or sheet over the outer surface of the cold-shrinkable type rubber insulation sleeve.

During application of the semiconductive rubber material over the reinforced insulation sleeve 11 to form the coating 17a and the contact coating 17b, the nozzle 21, instead of the core 19, may be rotated around the core 19 making reciprocating movement in the direction of the length of the core 19, while the core 19 is fixed. Moreover, the core 19 may be rotated and make reciprocating movement in the direction of the length, while the nozzle is fixed. Furthermore, the nozzle 21 may be rotated around the core 19, and the core 19 may make reciprocating movement in the direction of the length. Moreover, the coating 17a and the contact coating 17b may be formed by dropping the liquid semiconductive rubber material on the outer surface of the reinforced insulation sleeve 11, and then by spreading with a roller while rotating the core 19. The contact coating 17b may be arranged at only one of the semiconductive stress-relief cones 13 so that the coating 17a becomes conductive only with one of the semiconductive stress-relief cones 13. Furthermore, the coating 17a may be conductive with neither of the semiconductive stress-relief cones 13 without preparing the contact coating 17b.

As described above, according to the cold-shrinkable type rubber insulation sleeve of the present invention, since the reinforced insulation sleeve, the semiconductive stress-relief cone, and the internal semiconductive layer are formed by molding but the external semiconductive layer is formed by coating, a large mold and a large press to mold the external semiconductive layer are not required. Thus, the manufacturing cost for the cold-shrinkable type rubber insulation sleeve can be lowered.

In addition, it is possible to form the external semiconductive layer easily without considering stagnation or uneven flowing of the semiconductive rubber material inside the mold, and without trouble to control the molding pressure. The yield is also improved. Furthermore, it is possible to form the external semiconductive layer thinner in thickness than the conventional molded type without causing nonuniformity in the thickness. This also leads to improved manufacturing efficiency of the cold-shrinkable type rubber insulation sleeve because less time is required for formation, including processes of coating and curing, of the external semiconductive layer.

Moreover, because the reinforced insulation sleeve, the semiconductive stress-relief cone, and the internal semiconductive layer are formed not by coating but by molding, it is possible to obtain the cold-shrinkable type rubber insulation sleeve enough rugged and durable not to be deformed even while the cold-shrinkable type rubber insulation sleeve is kept expanded, or when the cold-shrinkable type rubber insulation sleeve is let shrink at assembly. It is also possible to stably maintain a desirable performance for a long time, and to enhance reliability.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of manufacturing and assembling a cold-shrinkable rubber insulation sleeve, the method comprising:
forming a tube-shaped internal semiconductive layer by injecting a semiconductive rubber material into a first mold;
forming two substantially tube-shaped semiconductive stress-relief cones by injecting a semiconductive rubber material into a second mold;
arranging the internal semiconductive layer and the two semiconductive stress-relief cones in a third mold so that one of the two semiconductive stress-relief cones is arranged at each side of the internal semiconductive layer, and that there is a predetermined gap between the semiconductive stress-relief cones and the internal semiconductive layer;
forming a one-piece reinforced insulation sleeve so that the reinforced insulation sleeve covers the internal semiconductive layer and both of the semiconductive stress-relief cones, by injecting an elastic material into the third mold;
removing the third mold;
coating a liquid semiconductive rubber material onto an outer surface of the reinforced insulation sleeve so that the liquid semiconductive rubber material coats the outer surface of the reinforced insulation sleeve;
drying and vulcanizing the coated liquid semiconductive rubber material to form an external semiconductive layer;
providing a removable protective layer on an outer surface of the external semiconductive layer;
keeping the cold-shrinkable rubber insulation sleeve expanded until assembly to a power cable joint; and
shrinking the expanded cold-shrinkable rubber insulation sleeve at the assembly to the power cable joint.

2. The method of manufacturing the cold-shrinkable rubber insulation sleeve according to claim 1, wherein the providing the protective layer on the outer surface of the external semiconductive layer includes providing the protective layer that is configured to be semiconductive.

3. The method of manufacturing the cold-shrinkable rubber insulation sleeve according to claim 1, wherein the providing the protective layer on the outer surface of the external semiconductive includes providing the protective layer that is configured to be one selected from the group consisting of a semiconductive tape, film, or sheet that is applied over an outer surface of the cold-shrinkable rubber insulation sleeve.

4. The method according to claim 1, wherein the removable protective layer is provided on the other surface of the external semiconductive layer before the shrinking the expanded cold-shrinkable rubber insulation sleeve at the assembly to the power cable joint.

5. The method according to claim 1, wherein the removable protective layer is provided on the other surface of the external semiconductive layer after the shrinking the expanded cold-shrinkable rubber insulation sleeve at the assembly to the power cable joint.
